(19) United States
(12) Patent Application Publication
(10) Pub. No.: US 2020/0116393 A1
(43) Pub. Date: Apr. 16, 2020

(54) MULTI-FUNCTION SOLAR COOKING APPLIANCE

(71) Applicants: HUAZI LIN, Richmond Hill (CA); W&E International (Canada) Corp., Richmond Hill (CA)

(72) Inventors: Huazi LIN, Richmond Hill (CA); Yuanhao LIN, Richmond Hill (CA)

(21) Appl. No.: 16/471,218

(22) PCT Filed: Dec. 21, 2017
(86) PCT No.: PCT/CA2017/000272

§ 371 Date: Jun. 19, 2019

(30) Foreign Application Priority Data
Dec. 21, 2016 (CA) 2952462
Dec. 12, 2017 (CA) 2988689

(51) Int. Cl. F24S 20/30; F24S 23/70; F24S 20/20; F24S 23/00; F24S 50/20; F24S 20/40

(52) U.S. Cl. CPC F24S 20/30; F24S 23/70; F24S 20/40; F24S 23/00; F24S 50/20; F24S 20/20

(57) ABSTRACT

A multi-function solar cooking appliance is disclosed. The appliance comprises a solar thermal unit comprising: at least one solar heat collector for collecting solar heat; a chamber of said solar heat collector for receiving a utensil and thermally connected said solar heat collector to receive and transfer said solar heat to said utensil for cooking; and a sunlight reflector having a cross section with a circular arc shape and said utensil. The appliance further selectively comprises a multi-functional cover, a modular solar thermal unit, assembled fluid channel, supplementary energy heater, different side chambers and/or utensils for heat insulation purpose; disposable utensil and ferromagnetic heat conducting and storage material.

### FIELD OF TECHNOLOGY

The present disclosure relates to solar cooking field, especially related to multifunction solar cooking unit/appliance and its inventive components. The unit can be assembled as portable and family styles solar cooking appliance to be used both indoor and outdoor.

### BACKGROUND

Since 2015, the world has entered into a new energy era. Solar energy will be the key energy in the future for all kinds of human energy consuming activities. Food (including coffee and tea) cooking is the most ancient and arguably, the most important energy consumption activity. Solar cooking is to complete all kinds of cooking processing by solar heat directly absorbed from sunlight. Solar cooking should be the daily activities of billions of people in the near future. Solar cooking development faces a serious of critical challenges. They are as follows: the uncertainty of weather how to meet the requirement of three time cooking every day; the low density of solar energy how to meet the fast and continued cooking requirement; long period of preheating in water may cause the deterioration and sour of the food immersed; outdoor sunlight—how to meet the indoor cooking requirement; sky sunlight how to make bottom heating; large size solar heat collector—how to fit smaller available space; roof sunlight vs. cooking on ground; the safety concern of the transparent glass used; heat insulation requirement; cost effective required from more populations; high efficiency for solar and other energies; to switch cooking energy between solar energy and second energies (e.g. electricity) flexibly and automatically; how to turn on/off and control the solar heat supply as did by traditional cooking appliances and how can make no significant changes to the traditional cooking habit and custom. To solve these challenges, we have developed a series of technologies and solar cooking appliances in last ten years. Some of them are disclosed in Canadian applications under the numbers of 2,672,760, 2,673,703 and 2,673,702 on Jul. 23, 2009. The applications also entered into many countries worldwide through PCT. After the last disclosures, a lot of further studies have done, many experiences have been gained. This disclosure reflects our continued efforts to solve the technical challenges mentioned above and others.

This disclosure provides a solar cooking unit/appliance that integrates following inventive features and components for further responding the challenges mentioned above and others. The challenges are as follows: an assembled fluid channel having one way liquid communication feature and two way gas communication feature; a modular solar thermal unit with one or two sunlight reflector(s) shaped as circular arc (e.g. semi-pipes) having all reflecting focuses in solar heat collector; a modular multi-function cover; a modular and separable heat conducting and storage material; a solar cooking unit for second kind of heating source; an electric heater, especially an induction cooking heater; a solar heat collector able to track sunlight in a limited and fixed area; a disposable utensil; a solar cooking appliance for indoor user; a 360 degree rotatable sunlight reflector; a sunlight reflector for turn on/off and control solar heat supply; at least two of chambers and utensils for automatically transferring between solar and supplementary energy heaters. The above features and components can also be used in different kinds of solar cooking appliances, solar thermal device and appliances with second energy selectively and respectively. Until today, at least some of the challenge mentioned above has at least one solution developed and disclosed through our prior patent applications including this application. The solar cooking appliances used these solutions can complete all kinds of traditional cooking processes by absorbing solar heat directly from sunlight. The solar cooking appliance can be safer, cost effective, user friendly, high cooking temperature, high energy efficiency, continued heat supply, easy to manufacture and use. They also can be used by indoor or outdoor user. Solar cooking does not generate greenhouse emission. It also does not generate harmful gas in a room or introduce harmful material into foods, as BBQ grills are prone to do. Solar cooking usually uses a temperature under 200 degrees Celsius to cook food, there is no concern of open fire. Solar cooking appliances can generate hot water, beverages and foods automatically without control device. Now chefs and diners can stay indoor to cook and eat solar cooked foods. There is no barrier for solar cooking to become popular energy consumption activities by billions of people in the near future.

### SUMMARY

This disclosure provides a solar cooking unit comprises: a modular solar thermal unit comprising: at least one solar heat collector for collecting solar heat. A chamber for receiving a utensil (also called cookware) and thermally connected said solar heat collector to receive and transfer said solar heat to said utensil for cooking. A multi-functional cover covered said utensil. The solar cooking unit can be used indirectly and directly for cooking. It also can be used to form solar cooking appliances. One of the examples is to provide a portable solar cooking appliance with one or two solar heat collectors.

The portable solar cooking appliance comprises: a modular solar thermal unit comprising: at least one solar heat collector for collecting solar heat. A chamber of solar heat collector for receiving a utensil (also called cookware) and thermally connected said solar heat collector to receive and transfer said solar heat to said utensil for cooking. Here modular solar thermal unit is provided for the purpose of safety, high efficiency and cost effectiveness. The modular solar thermal unit comprises: first evacuated tube solar heat collector with first sunlight reflector; second evacuated tube solar heat collector with second sunlight reflector; the cross sections of first and second sunlight reflectors are shaped as circular arcs respectively; and reflecting focuses of said circular arcs are located in said first solar heat collector and second solar heat collectors respectively. The focuses are at the ½ radius (R) of the circular arcs. When we arrange the solar heat collector at the center of the circular arc and the central line of said evacuated tube to locate in or approximately in the location of the half radius (½ R) of circular arc section, it is very easy to make sure every focuses can be arranged in the solar heat collectors. A connecting part connected two said reflectors; and said connected two reflectors not only being able to be opened for said two collectors to absorb solar heat, but also able to be closed for said first and second sunlight reflectors to form a complete pipe for said first and second solar heat collectors to locate in. Here the combined pipe can be a round pipe or an allotype pipe. Here the allotype pipe means a pipe combined by two reflectors with circular arc cross section. This means the reflector may be half pipe, ⅓ pipe or ¼ pipe etc. In both kinds of the pipes, the focuses of the reflected light are located in the inner space of said solar heat collector. For example when the combined pipe is a round pipe, we can arrange the central line of said evacuated tube to locate in or approximately in the location of the half radius (½ R) of said pipe. Here R is the radius of the round pipe. When said reflector is allotype /shaped pipe, we also can arrange the central line of said evacuated tube to locate in or approximately in the location of the half radius (½ R) of circular arc section of the reflector. Here R is the radius of the circular arc. Therefore all the focuses of reflected lights from said reflectors are located within the inner space of said evacuated tube. The evacuated tube can be a single tube, a plurality of tubes or a tube of modular solar heat collector. The tube may also have a plastic cover or it is a toughened-glass tube. The modular solar thermal unit also can be a plurality of said thermal unit to form a panel of a solar heat collector; wherein said panel having a mechanism to rotate the panel around the central vertical axis.

The modular solar thermal unit not only can be used in solar cooking unit. It also can be used independently to form other solar thermal devices such as a solar hot water system or solar space heating system. The solar hot water device further comprise a plurality of said thermal units, manifold/convergent pipe, a heat transfer liquid, insulation and supporting flame. A solar space heating device further comprises an electric power source, a fan and an air channel.

A solar cooking unit comprises: a solar thermal unit comprising: at least one solar heat collector for collecting solar heat; a chamber for receiving a utensil and thermally connected said solar heat collector to receive and transfer said solar heat to said utensil for cooking; a functional cover covered said utensil; and the cross section of said reflector having a shape of circular arc, and reflecting focuses of said circular arc located in said solar heat collector.

Another solar coking appliance for indoor user is provided. The appliance comprises: a solar heat collector for collecting and storing solar heat, having its main part arranged in outdoor for solar heat collecting and storing. An open end of said solar heat collector is opened indoor directly. A solar cooking utensil arranged in said solar heat collector for cooking. The utensil can be put into and took out from said solar heat collector within indoor space; a sunlight reflector able to rotate in 360 degree around the axis of said solar heat collector. A controller controls the movement of the reflector. The controller is able to be operated indoor. The solar cooking appliance according to above description may further selectively comprise one or more of following: an indoor monitor for monitoring said main part of said solar cooking appliance; a multi-functional cover as mentioned before; a heat conducting material and a heat conducting and storage material which are transferrable each other; a supplymentary energy heater heater or cooking appliance; a control motor, a sunlight tracking software, a fluid tube for fluid communication and a second utensil arranged outside of the solar heat collector. The details of above mentioned components are described in other part, especially in FIG. 7, of this application. To make the rotation of the reflector easier, the reflector may be made of a light and thin plastic with a reflecting coat on surface. The alternative way is that the rotated part is a transparent circular cylinder, coated the reflecting material partially. The other part is kept transparent for the protection of solar heat collector.

An outdoor solar cooing appliance is provided. The appliance comprises: a solar thermal unit comprising a solar heat collector for collecting and storing solar heat. A chamber receives a solar cooking utensil for food cooking. A multi-functional cover covers said utensil and may also the chamber. A reflector focuses and reflects sunlight to the solar heat collector. A stent interconnects and supports the elements of the appliance. The stent comprises a receiving structure to receive and detach kitchen supplies.

Following components or elements can be used in above mentioned solar cooking appliance. A supplymentary energy heater is an important part of a solar cooking appliance because the uncertainty of weather. Solar cooking appliance needs and can combine with any other energy heater or cooking appliance to form a multi-energy solar cooking appliance/range. For example, the supplementary energy heater can be any one of, gas heater, oil heater, coal heater and biomass heater. An ideal solar cooking appliance can integrate a supplymentary energy heater and switch between two energy heaters flexibly and freely. We also disclosed built-in supplementary energy heater in the solar cooking range/stove. The solar cooking range/stove is structured same as the existing range popularly used in market to meet cooking habit and custom of the kitchen workers.

The solar cooking appliance/range comprises: a solar thermal unit comprising: at least one solar heat collector for collecting solar heat; a chamber for receiving a utensil and thermally connected said solar heat collector to receive and transfer said solar heat to said utensil for cooking; a multi-functional cover covered said utensil; and said solar thermal unit further comprising a supplementary energy heater; and wherein said chamber having first open end to receive said utensil and second end located on top of a predefined heating zone of a supplementary energy heater; and a heat insulation separator isolated said chamber from said supplementary energy heater. Here the heat separator can be ceramic glass, ceramic glass with a heat insulator or a heat conducting material with a removable heat insulation. The appliance may further comprise one or more of a fan, a heat conducting and storage material and a control panel. To transfer the cooking heat source between two energies faster and easier, the chamber may have at least two chambers with different sizes; said utensil having at least two utensils to fit the shape and size of said chambers respectively. Here the second energy can be any energy except solar energy, such as electricity, oil, gas, coal and biomass. The fan is to remove smoke and/or control temperature of said supplementary energy heater. The control panel is for measuring, indicating and/or controlling the solar thermal unit and/or supplementary energy heater. The separator can be a heat conductor (e.g. a metal plate) with removable heat insulation, or a heat insulated and non-ferromagnetic material (e.g. ceramic glass). The separator not only protects the solar heat loss through supplementary energy heater, but also reduces the heat loss from supplementary energy heater to the heat conducting and storage material through the wall of chamber.

The solar cooking unit/appliance/range mentioned above may be integrated with one or more innovative components and features selected from following. The components are introduced and explained below. The purposes of the new features are also provided.

A pair of utensils with a flexible and assembled fluid channel is disclosed. The purposes of the fluid channel is as following: to allow one single solar cooking appliance for all kinds of cooking processing; to separate the ready beverage and boiled water from cold or warm water automatically without automatic device; to allow the dry food be separated from water until the water is boiled and cooking processing is automatically started. The last purpose is required, because due to the uncertainty of the weather and the relatively longer solar cooking processing, the food submerged in the water may become sour or deteriorated. The solar cooking appliance according to above mentioned solar cooking unit/appliance wherein said solar cooking utensil comprises: first utensil and second utensil; a flexible and assembled fluid channel removably and selectively connects said first utensil and second utensil for fluid communication; and said fluid channel having a feature to communicate liquid in one way and to communicate gas in two ways. One of the selective structures of the feature is a small hole on the channel and above the highest water lever in the second utensil. Here all kinds of cooking processing means food boiling, stewing, steaming, roasting, frying and making coffee, tea and boiled water.

As mentioned before, we always can cook the food and beverages in the first utensil directly. The difference between this kind of cooking and the direct cooking in the first utensil is as following: This kind of cooking can separate the dry and cool foods/beverages and water in two utensils. The real cooking processing is started only when the water is boiled in first utensil and is transferred into second utensil. At the boiling water preparing stage, the food is kept dry and cold. By controlling the water in first utensil and the length of tube in the first utensil, we can control and always only get necessary water for cooking. We also can control the cooking processing automatically without a control system and without over cooking of foods and beverages. The beverage in second utensil is always ready to drink.

In our solar cooking appliance, the chamber means a space defined by a wall for transferring received solar heat to said utensil for food cooking. The utensil is fully or partially located in the chamber. Usually the chamber is a space defined by a heat conducting wall and connected with a heat conducting and storage material, said chamber thermally connected to a solar heat collector. The examples of the chamber are as follows: an inner space defined by inner layer of an evacuated tube solar heat collector; a space within the solar heat conducting and storage material in a flat or camber plate solar heat collector; a space located in the heat storage and conducting material in a heat insulated compartment and thermally (indirectly) connect to the solar heat collector. The wall usually made of a heat conducting material (e.g. metal) and glass. If an induction heater is used, the wall material can be non-ferromagnetic material. (e.g. copper or aluminum). For a solar cooking unit with a supplementary energy heater, the chamber is located above the designed heating zone of the second heater and separated from the second heater by a ceramic glass or a heat conducting (e.g. metal) plate with a removable heat insulation. When the supplementary energy heater is an induction heater or an infrared heater, the separator can be a ceramic glass.

The induction heater is a preferred heater in a multi-energy solar cooking appliance. The reason is that the electric heat can heat the utensil only. At least two chambers with different sizes and two different size utensils to fit the size of chambers respectively. This special arrangement allows the utensils to receive the solar heat from the chamber wall at solar cooking style. At the induction heater cooking style, we can insert the smaller size utensil to the larger size chamber. An air gap will be formed between the wall and utensil for heat insulation. Therefore the heat from the induction heat can be used for food cooking only. The separator and second heater can also be an integrated ceramic glass with an electric-heat coating on the back. In this case, the coating connects to a power supply. When the electric current passes through the ceramic glass, the electric energy is converted to heat directly for cooking. When this kind of coating electric heater is arranged between the solar cooking chamber and the oven of said solar cooking utensil, it cooks the foods in both the chamber and in oven. A heat insulation plate selectively covers one of two sides of the heater. The heater also can be designed as removable from the appliance for repairing or replacing.

A multi-functional cover is provided for the following added features: A utensil has multi-cooking functions and can cook food and beverage automatically. The cover has a mechanical locking structure to make the utensil as an airtight container. The locking structure also makes the cover as a handle for moving the utensil. For example, it may be a pair of protuberances on the inner surface of the utensil and a pair of notches in the cover. They can be matched and locked to move the utensil. They also can let the cover to be released from utensil.

The cover may have three parts fixed or removably assembled together. The parts cover the inner space of the utensil, the gap between utensil and the wall of chamber and the gap between chamber and the cooktop respectively. The cover may have an electric connector connected to power source and being able to removably receive an electric heater. A perforated fitting is for receiving the assembled fluid channel. The cover not only can be used to cover the utensil, but also can be used for covering the second open end of the solar heat collector, if there is one. The heater in the cover may be selected from a group of a resistant heater, an infrared heater, an induction heater, a light heater, heater, a radiated heater etc. Here it is an immersion electric heater.

Most of solid, liquid and phase change material can be used as heat conducting and storage material, if the material can be heated to the temperature higher than water boiling temperature and do not generating harmful material. More heat conducting and storage materials are provided for above mentioned solar cooking unit and appliance. First a separable and joinable heat conducting and storage material is disclosed to allow the solar cooking appliance to operate in two modes. A first, fast cooking mode concentres all solar energy absorbed in the solar heat collector to the utensil. A second, “cooking and storage” cooking mode allow partial solar energy to be stored for followed and continued cooking. The material comprises a first material (e.g. metal container) mainly for heat conducting, and a second material mainly for heat storage (e.g. sand and salt). Said second material can be received in and removed out from the first material. The second material containing ferromagnetic material and a non-ferromagnetic material are also disclosed to meet the requirements of solar cooking appliance with an induction heater. The second heat conducting material can be selected from pure salt, clear sand, marble or ferromagnetic material (e.g. stainless steel balls). After the food is cooked, the second heat conducting material needs to be removed from the food using a try basket. The steel balls can be removed by a magnetic element

The solar cooking utensil can be a utensil located in the chamber. The utensil also can comprise first utensil located in the chamber and second utensil located outside of the chamber. The second utensil may be heat insulated i.e. the utensil has heat insulation or has two layers evacuated in between. The size of the utensil may be smaller than the largest size of said chambers and a sheet at bottom containing ferromagnetic material. The utensil also may be a set of utensils located in a plurality of the evacuated tubes. The utensil further can be a set of utensils arranged in a set of chambers which located in an enclosed compartment wherein heat conducting material is filed to receive solar heat from the solar heat collector. There are many kinds of utensils that can be selectively used for different cooking purposes. They are as follows: a pan, a boiler, a steamer, a frying pan, roasting pan.

In our prior patents and pagtent pending of solar cooking appliances, we have disclosed many kinds of utensils for solar cooking. For example, they are a pan, a boiler, a steamer, a frying pan, roasting pan. All of them can be used in the solar cooking appliances of this disclosure. The solar cooking appliance may become popular energy consumption for billions of population in the near future. A disposable utensil is disclosed to meet the requirement of preparation, storage and cooking in a large scale and industrial processing for solar cooking. The disposable utensil has a hole to connect the first end of the channel. The hole has a removable and attachable seal. The attached seal can help to make home- made canned foods for solar cooking. The utensil may be made of paper, plastic aluminum and alloy. The utensil may contain ferromagnetic material for induction heater. The utensil can be a box, a cylinder can and a bag. The food can be a beverage/shop, cooked food and fresh food for heating or cooking in the solar cooking appliance.

The solar heat collector can be any kind of solar heat collector able to heat the utensil to the temperature higher than the water boiling temperature. For example, evacuated tube solar heat collector and flat plate solar heat collector are two typical solar heat collectors that can be used.

The evacuated tube solar heat collector has two layers. The first layer is transparent made of transparent glass or plastic. The toughened/tempered glass and ceramic-glass are additionally included in the glass. The second layer can be glass or metal. The evacuated tube can be a single tube, a plurality of tubes or a tube of modular solar heat collector mentioned bellow. Evacuated tube solar heat collectors are selected for solar cooking very often, because they have very good heat insulation feature and a high working temperature. When the evacuated-tube solar heat collector is made of glass, in case the glass tube is broken, the broken glass pieces are dangerous for the user. So the solar heat collector may need a transparent cover for safety reasons. (not shown in FIG. 1). The transparent cover may be a plastic cover. It can be either the mantles for each tube or a protective cover for an entire collector panel. But the plastic protective mantles may reduce the efficiency of the solar heat collector. So an evacuated toughened-glass tube solar heat collector is a better solution, if it is available.

The solar heat collector can be one open end or two open ends. The collector can be oriented vertically, horizontally or in an angle less than 90 degree to the ground. Other shaped solar heat collectors are also can be used. For example, a camber solar cooking unit is also provided. The camber solar cooking unit comprises first camber transparent layer and second camber layer for absorbing solar heat. The first and second layers are insulated by air or evacuated in between. A heat conducting and storage material with heat insulation placed in camber space defined by said insulation and second camber layer. The material thermally connected to the solar heat absorber. The heat conducting and storage material is heat insulated. At least two chambers arranged in the heat conducting and storage material. Said chamber having first open end to receive said utensil and second open end located on top of a predefined heating zone of a cooking heater heated by a second energy; the size and shape of each said utensil fit the size and shape of one of said chambers respectively; a fan for removing smoke of file or for temperature control of said supplementary energy heater; and a heat insulated and non-ferromagnetic material (e.g. ceramic glass) separated said chamber from said supplementary energy heater; wherein said second energy is an energy except solar energy; a fan for removing smoke of fire and/or for controlling temperature of said supplementary energy heater; and a control panel for measuring, indicating and/or controlling the solar thermal unit and/or supplementary energy heater. Two vertical standing light reflectors arranged in two sides of the unit for reflect sunlight to said absorber. The plates can be rotated to track the sunlight and cover the absorber after cooking. A horizontal light reflector arranged at the front bottom of the unit for reflecting sunlight too. The plate also can be rotated to cover the transparent layer.

To allow the solar cooking appliances to be used in a traditional cooking way, a new solar thermal unit with plurality of vertical standing solar heat collector is disclosed. It can be used independently or to form the two energy source cooking appliance. A flat plate solar heat collector or a raw of evacuated solar heat collectors vertically stands and connected to a heat storage and conducting material on top. The cooking chamber and utensil are located in the material. A rotatable sunlight reflector plate(s) selectively arranged at the bottom of front door, right side and/or left side. The selection of the sides depends on the location (corner of wall, in door, or outdoor) of the appliance and seasons. The reflecting plate(s) can be closed to cover the solar heat collector and for heat insulation after cooking. The unit may further comprise an electric heater. The electric heaters can be selected as mentioned before.

Another modular solar thermal unit is also provided. The solar thermal unit comprises at least one solar heat collector for collecting solar heat. A chamber for receiving a utensil and thermally connected said solar heat collector to receive and transfer said solar heat to said utensil for cooking; said solar thermal unit further comprises a heat conducting and storage material thermally connected to said solar heat collector and a ceramic glass; said chamber arranged in said material; and said chamber having first open end to receive said utensil and second open end located on top of a predefined heating zone of a cooking range; said range is merged by a supplementary energy heater; and the ceramic glass separated said chamber and said supplementary energy heater. The supplementary energy heater is powered by any energy except solar energy. For example, the second energy may be gas, oil, coal and biomass. The examples of the electric heaters are infrared heater, microwave heater, resistance heater and induction cooking heater etc. They can be considered and selected. The second source heater further comprises a fan for remove smoke and control the temperature of the heater.

One or more food-admixable and induction-heatable objects are provided for mixture with food. They may be alternatively be referred to herein as “material mixed with food”. The material can be mixed with food and heated to promote fast and uniform heating of the food. The material, which may for example take the form of balls, nets or sheets, comprises ferromagnetic material for generating induction heat. The material may have an associated magnetic tool, which may be a kitchen or serving utensil such as a skimmer or draining spoon for checking and removing the mixed material after cooking. The material should be food-safe, i.e. should not contaminate fod or render it unsafe for human consumption.

The “material mixed with food”, the “removing tool”, the “insulated utensil” and the “two layer utensil” mentioned above also can be used for all kinds of cooking appliances with an induction heater.

As mentioned before, solar cooking appliance can ideally integrate a supplementary energy heater and switch between two energy heaters flexibly and freely. Electricity is the most convenient supplementary energy heater. In this disclosure more removable electric heaters are provided for selective use in solar cooking appliance. Such heaters may for example be electric resistance heater, induction heaters, infrared heaters, light heaters, immersion heaters, radiated heater and microwave heaters etc. The heater cooks the food by one or more chamber wall, utensil, heat conducting and storage material, one or more food-admixable and induction-heatable objects and a ferromagnetic material in the utensil. The heater can be located in the multi-functional cover, inside or outside of the utensil, inside or outside of the chamber, above or under the food. The electric power may be drawn from a vehicle battery, electric power bank, solar-electricity unit or utility power system. The electric heater usually is separated from the chamber by removable insulation and a heat conducting material (e.g. metal plate). The insulation is to avoid the solar heat lost to the space of second heater. For the induction heater and the infrared heater, a ceramic glass can replace insulation and a heat conducting material. In some cases, the separator and second heater can also be integrated. It is ceramic glass with an electric-heat coating on the back or between two pieces of the ceramic glass. In this case, the coating connects to a power supply. When the electric current passes through the ceramic glass, the electric energy is converted to heat directly for heating the utensil.

We also disclosed build-in electric heater in the solar cooking range/stove. The solar cooking range/stove may be structured the same as existing ranges popularly used to meet cooking habit and custom of kitchen workers. When the solar cooking utensil is directly or indirectly heat insulated, the electricity efficiency can be very high. Even if no solar heat is used, the electricity efficiency of solar cooking utensil may still be higher than the efficiency of some commercial available electric cooking appliances. The reason is that the heat released from the heater and/or utensil to the ambient surrounding (e.g. room) may be reduced, since the heat conducting and storage material may absorbe such heat for further use before it is lost.

The electric heater may be one of many choices. In one example, an induction cooking heater for solar cooking appliance is provided to form a solar-electric induction cooking appliance. The induction heater comprises: a high frequency (e.g. 24 KHZ) AC electric power source; an electric coil connected to said power source, said coil having shape and size to closely fit the shape and size of the cooking chamber or a solar cooking utensil; a temperature sensor or a thermostat; and a controller. The shape of the coil can be that of a tube, plate or both. The electric heaters may have a low and safe AC or DC voltage (e.g. 12V, 24 V or 36 V) with a high temperature cable (e.g. 250 degree Celsius and more). It may be battery voltage of vehicles or the safety voltage allowed in wet places. Therefore, an electric transformer or an electric adapter may require.

The solar cooking appliance with supplementary energy source allows the cooking processing to continue uninterrupted, regardless of weather conditions of time of day, more stable than solar cooking appliance lacking supplementary energy sources. The appliance can accordingly be used much like a traditional cooking appliance, despite its use of solar energy. The challenge of this kind of appliance is that the supplementary heater usually needs to heat the heat storage material in the appliance. The material may store large amount of heat. In this solar cooking range, the special arrangement may be as following: the chamber wall and the heat conducting and storage material may be made of non-ferromagnetic materials while the utensil may contain ferromagnetic material. Therefore the induction heater can heat the utensil and food only. No electric power is consumed for the purpose of heating the heat conducting and storage material. Furthermore, we arrange at least two chambers and utensils having different sizes than previously disclosed can be provided. When the food is cooked by solar heat, the two utensils are located in the two chambers having sizes to fit the sizes of the utensils. When solar energy is insufficient for cooking, a smaller sized one of the utensils can be placed in the larger chamber for cooking by induction heater. The utensil or chamber may be sized and shaped so that an air gap is automatically formed between the chamber wall and the utensil wall. The gap acts as a heat insulator to protect the electric heat transferring from utensil to the wall. A larger size utensil can be used on the top of the smaller chamber. We only need to add a cylinder of heat storage and conducting material into the chamber for conducting the heat to the utensil. The cylinder contains ferromagnetic material and has a size smaller than the size of the chamber. Or we can arrange an electric heater directly heat the utensil without going through a chamber.

The efficiency of a solar cooking appliance can be improved by causing its solar heat collector to track the location of the sun in the sky as the earth rotates. In one example, the solar heat collector can be rotated using wheels to track the sun. However, such a solar heat collector may be poorly suited for constrained spaces in which the solar collection equipment may be obstructed from movement. Furthermore users may prefer to locate a solar/electric cooking range/stove indoors while the solar heat collector is outdoors. Therefore it may be difficult to rotate a solar cooking range for tracking the sun's apparent movement. An oblique angle and a single point adjustment solar heat collector is provided to solve this challenge. The solar heat collecting panel can be rotated around a point on the panel or a vertical central line.

The collector may have a inverted V (Like the caret symbol ̂,) with an upward pointing apex, a convergence pipe on the top of apex ̂ for interconnecting and receiving a set of non-orthogonal liquid tubes arranged on two sides of the convergence pipe. A first and higher end of the pipe connected to the range with a flexible connection (e.g. ball shape connection or a flexible tube connection). A second end of the pipe may be supported by a height adjustable supporter (e.g. a screw) to adjust the height of the supporter, and therefore the angle of the collector with respect to sunlight direction. The height adjustment can be made by an automation device, or by hand, e.g. monthly or weekly. Another solution is to make the solar heat absorber/collector plate-shaped. The absorber/collector may have a structure, (e.g. gear) to rotate the collector around the center axis of the convergence pipe to track the movement of sunlight. A second end of the pipe is supported by a height adjustable supporter (e.g. a screw) to adjust the height of the supporter, and therefore the angle of the collector will respect to sunlight direction.

Another solution is to locate solar cooking appliance at the south face front or corner of the building. The solar heat collector of such an appliance can be an evacuated tube, semi-rounded tube or flat plate solar heat collector. Said solar heat collector is arranged perpendicularly, parallel to or at an angle with respect to the ground on at least one side of the appliance. One or a set of automatic rotated light reflectors (e.g. rotated between front bottom, right side, and/or left side or in 360 degree) can replace the rotation of the collector. For example, when the appliance is arranged at the southeast corner of the building, the solar heat collector can be arranged at left and front sides of the appliance. When it is used out door, the solar heat collector can be arranged at left, right and front sides of the appliance. The solar heat collector comprises sunlight reflector able to rotate for tracking sunlight and for closing the solar heat collection after cooking. The solar heat collector may have an automatic controller.

A solar heat collector is provided. It comprises a plate shaped solar heat absorber having a convergent pipe at the center of said absorber; a structure to rotate the collector around the center axis of the convergence pipe; first end of said pipe connected to solar cooking unit flexibly; and second end of said pipe supported by a height adjustable supporter;

A solar heat collector arranged perpendicular to ground on at least one side of said appliance, said solar heat collector comprising sunlight reflector arranged in at least one side of the solar heat collector selected from right, left and front sides; said reflector being able to rotate for tracking sunlight and for closing the solar heat collector after cooking.

Other aspects and features of the present disclosure will become apparent to those ordinarily skilled in the art upon review of above introduction and the following description of specific embodiments of the invention in conjunction with the accompanying figures.

### BRIEF DISCRIPTION OF THE DRAWINGS

The advantages related to the present invention can be further understood via the following detailed description and drawings.

FIG. 1 is a schematic side view of an exemplary solar cooking unit

FIG. 2 is a perspective view that illustrates schematically a modular solar thermal unit.

FIG. 3 is a schematic diagram illustrating an exemplary multifunction solar cooking appliance/range in traditional range style.

FIG. 4 is a schematic diagram illustrating another exemplary solar cooking range.

FIG. 5 illustrates schematically an alternative solar and fire cooking appliance.

FIG. 6 a schematic side and front view of an exemplary outdoor solar cooking appliance.

FIG. 7 illustrates a group of exemplary solar cooking utensils.

### DETAILED DESCRIPTION

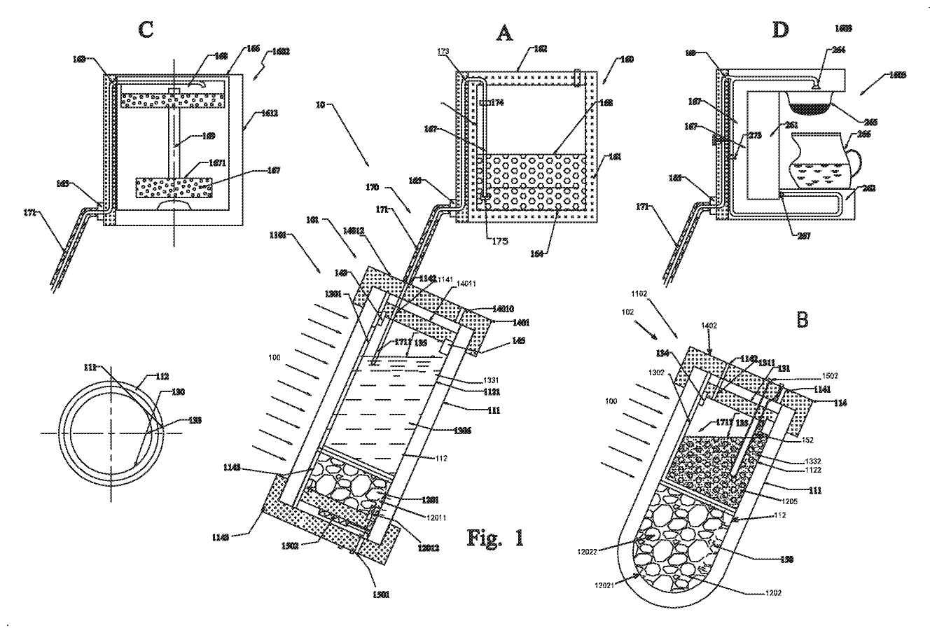

Refereeing to FIG. 1, solar cooking appliance 101 and 102 with evacuated tube solar heat collector1101 and 1102 are illustrated in vertical and cross section views. The collectors 1101 and 1102 have two layers 111 and 112, and evacuated space in between. The layers can for example be two glass layers, a glass layer with a metal layer or a transparent plastic layer with a metal layer. The tube has solar heat absorbing coat in the outside surface of inner layer 112. The solar cooking appliance is intended to be able to perform different types of cooking. The two evacuated tubes 1101 and 1102 will be used to describe the different cooking processing that can be performed by one appliance. It also shows that the evacuated tube solar heat collector can be one open end (1102) or two open ends (1101). Both of them can be used for solar cooking purpose. The solar cooking appliance has a chamber that can be any kind of space thermally connected to solar heat that received by the collector. Here the chambers 1121 and 1122 are the inner spaces 1331 and 1332 of the tube 1101and 1102 enclosed by inner walls of the tubes.

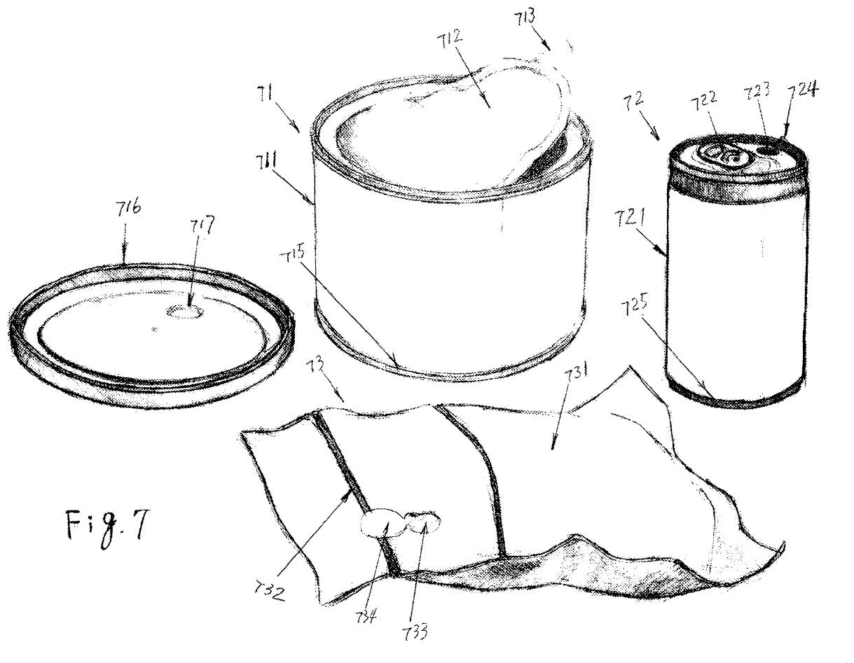

The appliances 101 and 102 have first utensil 1301 and 1302 located in the chamber 1121 and 1122 respectively that have the size and shape to fit the size and shape of the chambers. In this document, the term “utensil” refer to rigid or flexible containers or packages, including disposable containers or packages, e.g. shown in FIG. 7 (described below) that may contain water, beverage or solid or liquid food. Multi-functional covers 1141 and 1142 cover and heat insulate the utensil 1301, 1302 and the open ends of the tubes respectively. Third multi-functional cover 1143 covers the second end of the tube 1101. The covers have same structures except the second electric heaters 1501 and 1502. So the structure and function of the three cover can be understood with reference to the description of one cover 1401.

The cover 1401 has first part 14011 covers the utensil, second part 14012 that covers the gap between the utensil and chamber, and the gap between the chamber and the cooktop. The cover 1401 has a mechanical locking and releasing structures 143 and 145 (e.g. spirals) to make the utensil an airtight container and make the cover a handle for moving the utensil. The cover 1401 has first air hole 14010 that connects the inside and outside of the chamber 1121. The second fluid channel 170 is an assembled channel comprising a set of selectively assemble and removable fluid tubes 171, 172 and 173. Fluid tube 172 is located in the utensil 1301 and connected to the cover. Fluid tube 171 connects the cover with a second utensil 160 that located outside of the solar heat collector. 173 is arranged in the second utensil 160. Fluid tube 173 has a part 167 that is submerged in the food and an air hole 174 located higher than the liquid level 168 in the utensil. 167may also have a net 175 at the end of 167 to allow liquid and steam passing through while prevent solid food from entering the channel 170.

The utensil 160 may be heat-insulated by insulation 161 and has a lid 162. It also can be a transparent and two layer liquid container 1602 with a tea holder 169 as shown in C. The utensil 160 can also be a coffee pot 1603 as shown in D. Container 1602 and coffee pot1603 may be as described in prior patent application. The covers may also have removable and attached electric heaters 151 and 152 with electric connectors 1501 and 1502 respectively. The electric heaters may for example be microwave heaters, infrared heaters, resistant heaters, induction heaters and light heaters.

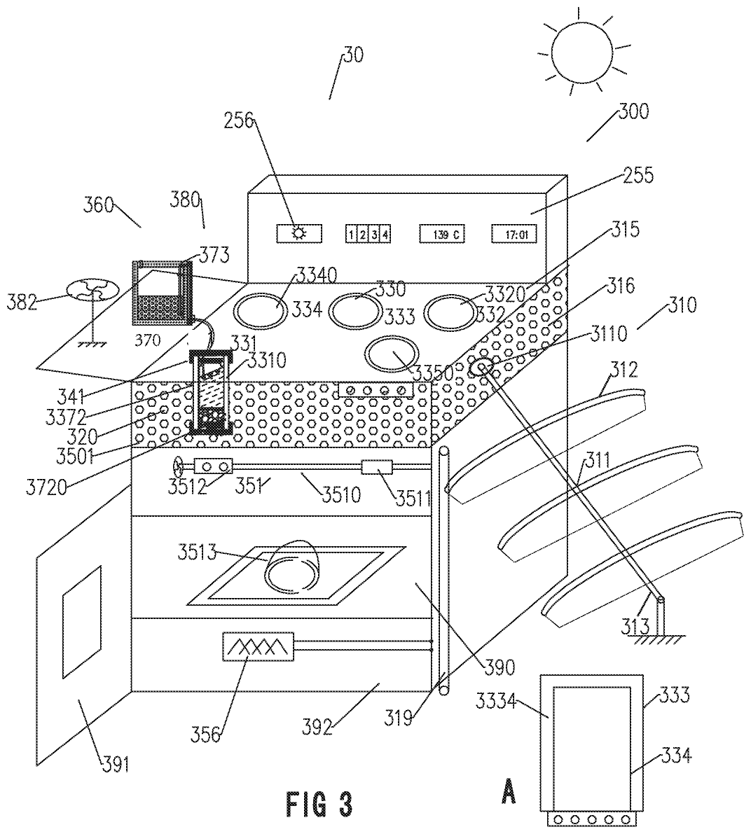

In FIG. 1, 1502 is an immersion heater with a power supply. 1501 is an induction heater. The coil shape can be round tube, circular plate or a tube connected to a plate. The induction heater will be described in FIG. 3 in details. The description of the induction heater in FIG. 3 can copy to here. The electric heating source can be selected from a group of: power bank, vehicle battery, solar electric generator and utility electricity.

The appliances further comprise heat conducting and storage materials 1201 and 1202. The materials can be any material able to heat to the temperature higher than water boiling temperature. For example, they can be solid material, liquid material and phase change materials. For induction heater, a ferromagnetic or non-ferromagnetic material can be used. Here a separable and combinable material 1201 is used. The material 1201 has a first material 12011 mainly for heat conducting. Here it is an empty cylinder made of heat conducting material (e.g. copper or aluminum). It is used when solar radiation is strong and a cooking processing needs to complete faster. The second material 12012 is mainly for heat storage (e.g. sand, salt, oil etc.). For the heater 1501, the material is ferromagnetic material. The second material can be received in and removed out from the first material. The material 1202, 12021, 12022 have same feature as 1201, 12011, 12012.

When sunlight 100 shines on the solar heat collector 1101, the collector absorbs the solar heat to heat the utensil 1301 and the heat conducting and storage material 1201. The multi-functional cover 1401 covered the utensil. Initially none of the assembled tubes 171, 172 and 173 is connected to the multi-functional cover 1402. The food will be cooked in the utensil 1302. The material 1202 will provide stored heat for a continued cooking as shown in FIG. 1 B. When the does not permit effective solar heating (e.g. when it is cloudy), the immersion heater 1502 can be connected to the power source for electricity to cook the food. In one example, the food may be nut for baking or toasting. A second kind of heat conducting and storage material 1205 is mixed with the nut. It is a ferromagnetic material. After cooking, a magnetic tool (e.g. skimmer or draining spoon, not shown in FIG. 1) can be used for separating the food and material. The utensil 1301 of FIG. 1 can cook food in the utensil directly and in any kind of cooking processing too (e.g. by baking, roasting, boiling, steaming, flying etc.), when the channel 170 is not connected. Here we introduce a different cooking processing. We put water in the utensil 1301. We connect the tubes 171, 172 and 173 as shown in FIG. 1. The open end of the tube 172 is submerged into the water. The second kind of utensil 1601 has dry rice or noodles arranged. When the solar heat heats the water 1306 to boiling, the vapour gathered in the utensil will force the boiled water to go through the channel 170 and get into the utensil 1601 to cook the food. After the water level 135 is under the end of the tube 172, water steam will follow and continue the cooking processing. In case the water stops boiling, the hole 174 will prevent the liquid to flow back to the utensil 11301. The net 175 will prevent the solid food to go into the channel 170.

The utensil 1601 also has a hole in the lid for air exchange. The utensil 1601 can be changed to a steamer (not show in FIG. 1), a tea or a hot water container 1602 and a coffee pot 1603 as show in FIG. 1 C and D respectively. Therefore by controlling the water level 135 in the utensil 1301 and the length of the tube 172, we can boil steam and stew food in the utensil 160 automatically without a controller. Furthermore the food in the utensil 1601, 1602 and 1603 can keep dry food and tea/coffee until the water is boiling to start the cooking processing. When an electric heater is required, simply attached the electric heater 151 to the cover 1143 and connect the connector 1510 to a power source and turn on electricity. The induction heater will be further described in details in FIG. 3. Like the utensil 1603, the utensil 1601 and 1602 can also have an electric heater.

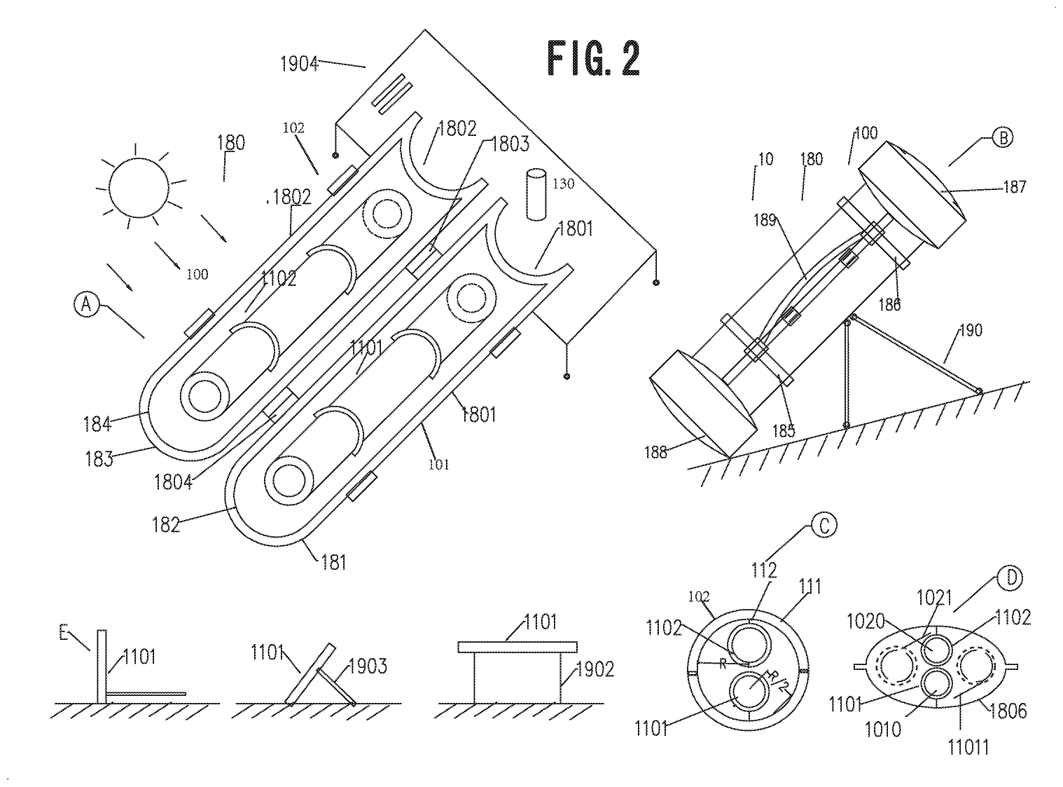

Referring to FIG. 2, a schematic diagram of an exemplary modular solar thermal unit 180 is illustrated in schematic side and section views. The unit 180 comprises two semi-modular solar thermal units 1801 and 1802. The pair of semi-modular units 1801 and 1802 comprises a pair of evacuated tube solar heat collectors. The collectors can be any evacuated solar heat collectors. To make the description simpler, the collector 1101 and 1102 are used as examples. They are described in FIG. 1. When the components in FIG. 1 and FIG. 2 are combined, a portable solar heat collector with two solar cooking appliances can be formed.

The solar heat collector 1101 and 1102 are arranged and fixed in two semi-pipes (18011 and 18021) respectively. Each said semi-pipe 18011 or 18021 has a base material 181 or 183 and a light reflecting layer 182 or 184 on its inner surface respectively. The focuses of the reflected sunlight from semi-pipe 1801 or 1802 are located in the inner space of the evacuated tube 1101 or 1102 respectively. The semi-pipe can be made of plastic, metal, wood, bamboo, carbon glass, fibre glass with epoxy, clay (ceramic pipe) or other material including combination thereof. The light reflecting layer 182 or 184 may be a reflecting coat, or a reflecting membrane/foil plates on the inner surface of the semi-pipe. The semi-pipe can also be a polished metal (e.g. aluminum) semi pipe.

Connection part or parts 1803 and 1804 (e.g. hinges), connect the two semi-pipes. The two semi-pipes 18011 and 18021 can be opened for said collectors 1101 and 1102 to absorb solar heat as shown in A of FIG. 1. They also can be closed to form a completed pipe 180 as shown in B of FIG. 2. Two hoops 185 and 186 with two screw holes can be used to close the pipe for safe transportation and storing. The hoops 185 and 186 also can be used for fixing the semi-pipes on supporting frame 190 (only part of the frame is showed in FIG. 2) of the unit 180.

Two end caps or couplings 187 and 188 may be arranged at the two ends of the pipe to replace or add to the hoops for closing the pipe and for safety reason. 187 and 188 can cap the pipe from outside (as shown in FIG. 2) or inside (not shown in FIG. 2). The pipe 180 can be a round pipe having a circle diameter 2 R as shown in C. One of the selections is that the axis of the evacuated tube 1801 and 1802 are arranged at the center of the semi-pipe and at location of ½ R height of the pipe 180. In this case, the central lines of the tubes 18011 and 18021 are followed (exactly at or very close to) the reflect focus points of said semi-pipes. All the reflected light from 182 and 184 of semi-pipes 18011 and 18021 will reach the solar heat absorb layers 182 and 184 of the corresponding solar heat collectors 1101 and 1102 respectively.

The semi-pipe can also be an allotype semi-pipe with any shape. The semi-pipe may be a part of a round tube with a certain arc angle, i.e. round camber plate. An allotype pipe 1806 is exemplary illustrated in schematic vertical section view in D. The key point is that all the reflected lights from said semi-pipe can reach the absorbing surface of said evacuated tube 1101 and 1102, whatever the sunlight is from any direction. In other word, all the reflecting light from each semi-pipe should be toward and reach the corresponding absorbing layer. The focuses of the reflecting light should be located in the inner spaces of the tubes 1101 and 1102 respectively. Therefore either in the round pipe case or in the allotype pipe case, the arrangement of the collectors allows all the reflecting light from the light reflecting surfaces 182 and 184 to reach the absorbing surface of the solar heat collector, whatever the sunlight is from any direction. To save material of the allotype pipe, the supporters 11011 and 11021 also can be adjustable. It allows the two larger evacuated tubes to be located in two sides of the pipe when the pipe is closed for transportation. It shows in dotted line in D of FIG. 1.

The glass tube may be brittle (fragile and sharp). It causes some safety concern to the operation and transportation of the collectors. The glass tube is fully located in the semi-pipe of the solar thermal unit mentioned above. The semi-pipes can protect the tubes in operation. The closed pipe can protect the tubes in storage and during transportation. The semi-pipes further play a role as a supporting element and packaging material for the solar heat collector. A semi-pipe also can be manufactured by stamping or pressing processing. The semi-pipe also can be made by cutting a pipe in two halves or in several pieces. The manufacture processing of a plastic or metal pipe is easy and cost effective. The pipe shape structure makes the manufacture of the semi-pipe, therefore the modular unit easy to manufacture and cost effective. The solar thermal unit 180 not only can be used for the solar cooking appliance. It also can be used in any other kind of solar heat appliances, such as solar hot water system and solar space heating system. For a solar hot water device it may further selectively comprise fluid manifold, (convergent) pipe, heat pipe, heat storage and conducting material, a heat insulation, a fluid container, a pump, a controller and/or other accessories. Furthermore more than one modular solar thermal unit can be connected through connecting parts or hinges to form multi-units.

When in operation, the unit 180 can can be placed in vertically, horizontally or at an angle with ground as shown in E of FIG. 2. The unit may further comprise a utensil (e.g. 130), a portable table 1904, connection channel and other components. The table has a set of notches to fit the shape of the pipes for receiving the semi-pipes. The cooking processing will also be described in FIG. 2. These components described in FIG. 1 and FIG. 2 (e.g. 101, 102, 1801 and 1802) can be combined to form a complete portable solar cooking appliance 10.

Of cause, the semi-pipes mentioned above also can separately be used in two single solar cooking appliances, e.g. 101 or 102. The single appliance comprise a solar heat collector 1101 or 1102, a cooking utensil 130 can be arranged in solar heat collector for cooking, a reflector shaped as a semi-pipe or a having a cross section with a circular arc shape.. The reflector may also be used for fixing and supporting the solar heat collector and as a package. A transparent bag cover the solar cooking appliance to cover the package for saving packaging material. The product information may be printed on the outside surface of the reflector. Furthermore, either or both solar cooking unit(s) of 101 and/or 102 may have a cover (not shown in FIG. 1 and FIG. 2) to cover the opened space formed by the base material. The cover may be used during transportation only. Or it can be used in both transportation and operation. The material of cover may be transparent for the sunlight to pass through when used in operation. The base material may be (not have to) has a slot for the cover to insert in or removed out from the base material.

Referring to FIG. 3, a multifunction solar and electricity cooking appliance 30 is exemplary illustrated in partial vertical section view. This appliance 30 is a solar and electricity range (also refered to as a stove). The appliance/range comprises a solar thermal unit 380. The unit comprises following components: a solar heat collector 310, a heat insulated compartment 316 thermally connected to the collector 310. The solar heat collector can be any kind of solar heat collector such as flat plate solar heat collector and evacuated solar heat collector that can heat the utensil to the temperature higher than the water boiling temperature. The collector may be a single collector or a plurality of collectors. The collector can be a row of evacuated solar heat collectors (390 shows one collector as a representation) vertically stands and connected to a heat storage and conducting material 320 on top. The collector can be selectively arranged at one, two or three sides of the appliance. They are back side, left side and/or right side of the range. Here the collector is arranged at the right side as a example. The collector has a central heat transferring conduit 311 to collect the solar heat from a set of branch heat transferring conduits 312. 311 has oblique angle to ground. A plate solar heat absorber or a set of evacuated solar heat collectors connect to the conduits and transfer the solar heat to the compartment. The collector can rotate around the center conduit 311 with a rotating structure (e.g. a rotating ball 3110). The collector also has an adjustable support 313 to adjust the angle to ground. The solar cooking appliance/range further comprises a set (at least two, here is four) of the chambers 331, 332,333, and 334 are arranged in the compartment and closely connected to a heat conducting and storage material 320. The material may be a non-ferromagnetic material when an induction heater is used. A set of first kind cooking utensils 3310, 3320, 3330 and 3340 have sizes to fit the sizes of the chambers331, 332, 333, 334 and 335. Some utensils did not show in FIG. 3. They can be received in the chambers respectively for solar cooking. A set of multi-functional covers covered the utensils and chambers. The covers have introduced in FIG. 1. The chambers and utensils may have different sizes. The smaller size utensil 3340 can be received in the larger size chamber (e.g. 333) for electric heater to cook food. (as shown in A of Fig.3) There is an air gap 3334 formed for heat insulation when electricity cooks the food. At least one utensil 360 locates outside of the chambers. An assembled fluid channel 370 removeably and selectively connects the utensil 331 and the utensil 360 for fluid communication. The fluid channel 137 has a variable length or several connectable sections for using in different cases. The channel has three opening point for fluid communication. They are first open end 3710 in the utensil 3310, second open end 3730 in utensil 360 and third opening point 374 in the hole 374. 374 is higher than the liquid level 368 in the utensil. The open end 3730 may further has a net 375 to allow the liquid going through and protecting the solid food material get into the channel. 1. At least a multi-functional cover 3401 covers the utensil 3310. The multi-functional cover 3401 has the same features as cover 1401 disclosed in the description of FIG. 1. This arrangement and working processing are the same as the channel 170 and utensil 1301 and 160 in FIG. 1. The above description of component numbers 1xx in FIG. 1 is applicable to the components 3xx of FIG. 3.The chambers 331-334 are arranged on the tops of the designed heating zones of a set of electric heaters respectively. A heat insulation separator 3501 (e.g. a ceramic glass) isolates the chamber and the electric heater. The sizes of four chambers 331-334 may be one larger than another in order, or at least include one chamber of a larger size than the others. An oven 390 with a door 391 and a drawer 392 are also provided. The oven uses same electric heaters for utensils or another kind of electric heater 356 (e.g. an infrared heater). A cooktop 315 covers the range. The cooktop has a set of holes for the utensils to pass through. Each hole has a corresponding chamber cover. The cover can be the multi-functional cover or cooktop covers (did not show). A control panel 255 is above the cooktop or under the cooktop for measuring, indicating and control the cooking processing. A liquid tube 383 arranged in the range for generate hot water. A fan 382 generates hot air. The fan can be arranged in oven and removably in one of the chambers. We also can use the fan for heater and add a controller to control the fan.

All the components are arranged in a shell to form a completed range. A magnetic strength and overheat warning device 256 is arranged at the control panel. The range may have one electric cooking heater 335 that is directly arranged under the cooktop without connecting any of the chamber and heat conducting and storage material. The heater is used by the largest size utensil and any other utensils with any special size and shape when the range is at electricity cooking style.

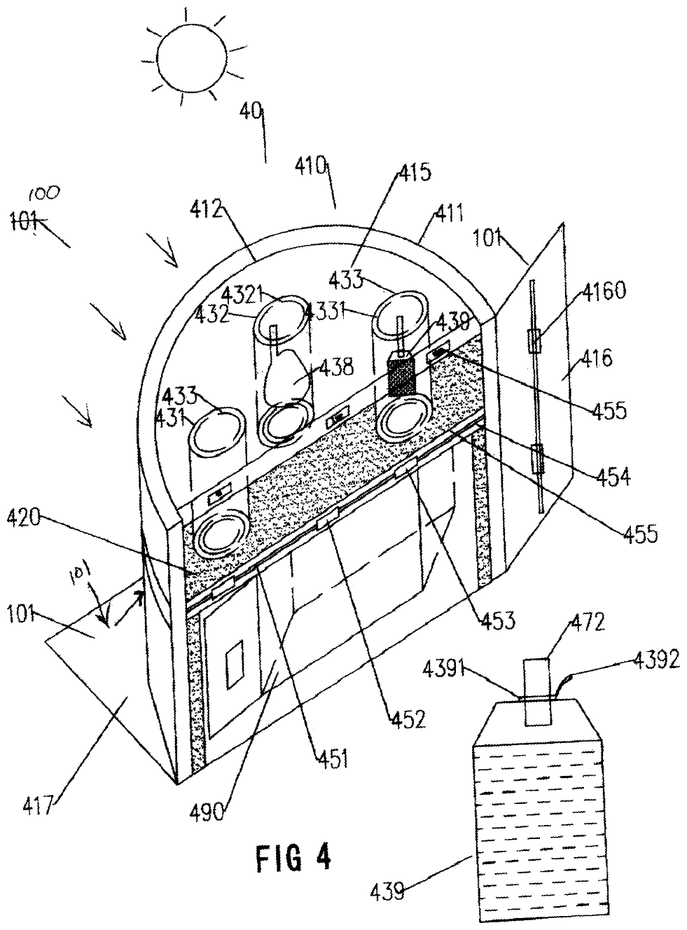

For easy transferring between solar cooking and second heater cooking, there is another alternative solution. The chambers 3310-3340 may have the same size. The utensils have two different sizes. The larger size utensils fit the size of the chambers for solar heat cooking. When the supplementary energy heater is in operation, the smaller size utensils can be inserted into the larger size chambers. There is an air gap between the chamber wall and the utensil wall for heat insulation. It is same as shown in A of FIG. 3. The detailed example will described in FIG. 4.

When sunlight 300 shines on the solar heat collector 310, the absorbed heat by the collector 310 is transferred to the heat storage and conducting material 320 that placed in the compartment 316 and the solar heat collector 310. The solar heat will cook the food in the utensils. The chamber wall 331-334 made of heat conducting material (e.g. metal) transfers the solar heat to the utensil 3310-3340 for cooking food in the utensil when the chamber sizes fits the utensil sizes. The multi-functional cover (e.g. 341) has a part closely attached to the cooktop 315 for preventing the cooking fluid leaked to the chambers.

When electric heating is required, the small size utensil 3340 can be moved from the chamber 334 to a larger size chamber 333. An air gap 3334 will be formed between the utensil wall 3334 and chamber wall 333 as heat insulation. To turn on the electric heater 353, the heater will heat the utensil 3340 at the bottom of the utensil only. The leaked heat from utensil will be transferred to the heat storage and conducting material 320 and stored for next solar cooking or for hot air (though fun 382) or hot water (through water tube 383). This range has no heat loss to the surrounding investment as other ranges do. Here the fun 382 can be located in the chamber, on or under the cooktop. The electric power souce and the heater can be many kinds of electric sources and heaters as mentioned in the description of FIG. 1.

In FIG. 3, five induction cooking heaters are used. Heater 351 is described as an example. 352, 353 and 354 have the same structures. The heater 351 comprises a high frequency power source 3511, a coil 3510, a fan 3512 and a thermostat or temperature controller included in control panel. The chamber 331 has first open end 3311 for receiving the utensil and a second end 3312 located on a predefined heating zone 3513 of the induction cooking heater 351. A heat insulation separator (e.g. ceramic glass) isolates the chamber from the induction heater. The walls of chambers and the heat storage and conducting material 320 are made of non-ferromagnetic materials. For example the chamber wall is made of copper or aluminum. The utensil (at least its bottom) is made of or contains ferromagnetic material or attached with a ferromagnetic material.

When the electric power turns on, an AC current is generated in the high frequency (e.g. 24 kHz) power source 3511. The current passes through the coil of copper wire 3510. The resulting oscillating magnetic field induces a magnetic flux to repeatedly magnetize the ferromagnetic material in the utensil. Therefore large eddy current is generated to produce heat at the resistance of the utensil for food cooking. Of cause, we can also allow the wall of the chamber containing ferromagnetic material (e.g. stainless steel). The induction current will heat both chamber wall and the utensil wall to cook food. In this case more electric heat may be transferred to the heat conducting and storage material.

In some cases, the heat insulated compartment 316 including its chambers may be removed for the range to be used as a regular induction cooking appliance. In the chamber 331, another utensil 360 is arranged outside of the chamber. A multi-functional cover 341 covers the utensil and chamber, An assembled fluid channel 310 is arranged. In this case, following components have the same features: chambers 1301 and 331, utensils 1301 and 3310, multi-functional covers 1401 and 341, heaters 1501 and 351, assemble fluid channel 170 and 370, utensils 160 and 360 and heat conducting and storage materials 1201 and 1202. Therefore all the description in FIG. 1 of these components is applicable to FIG. 3. For safety reason, at least the top wall of the heat insulated compartment contains ferromagnetic material.

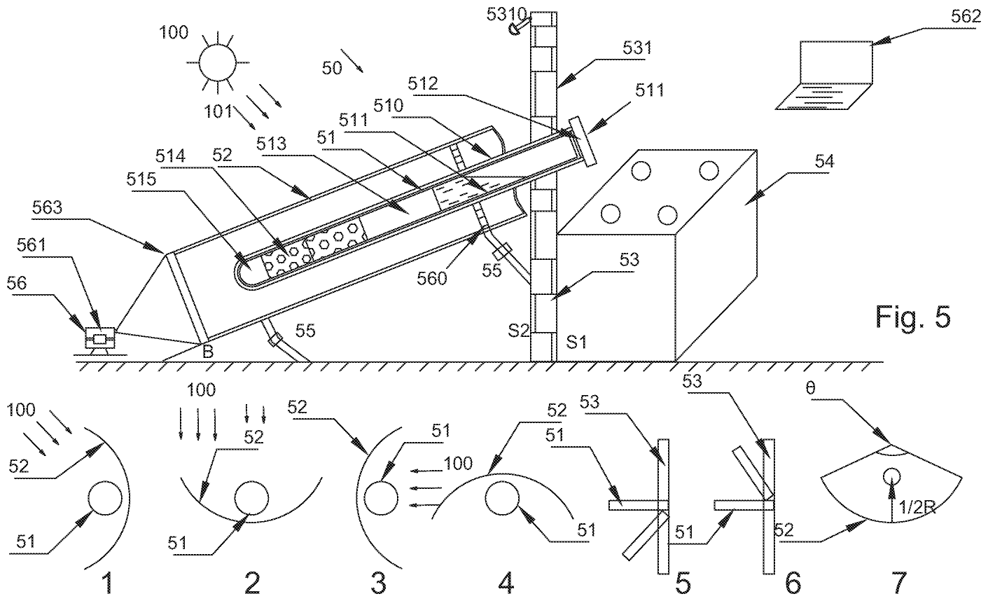

One of the important challenges of solar cooking is as following: The solar heat absorber has to be located outdoors, but the cooks/chefs may prefer to prepare and cook foods indoors. The diners may also prefer to eat their foods indoors. For safety reasons, the parents also like children to stay away from cooking appliances. Therefore it is advantageous to develop a solar cooking appliance for indoor user with a solar heat collector located outdoor. The solar cooking appliance shows in FIG. 3 reflects the effort of the development. Some prior indoor style solar cooking appliances including FIG. 3 arranged an outdoor solar heat collector and transfer the collected solar heat to an indoor stove by a heat transferring fluid. This kind of solar cooking appliances can have a large heat capacity, but may have lower heat efficiency. The solar cooking appliances of FIG. 4 and FIG. 5 show another kind of solar cooking appliances how to cook the food indoor and keep the advantages of compacted solar cooking appliance. The key point of those appliance is that the solar cooking utensils are located directly in the solar heat collector.

Referring to FIG. 4, an exemplary alternative solar cooking appliance 40 is illustrated in vertical view. The range has a plate solar heat collector 410. The plate can be a flat plate or a curved plate. Here it is a camber plate. The collector comprises a transparent plate 411 for sunlight to pass through and heat insulation and a solar heat absorbing plate 412. The appliance has chambers 431, 432, and 433 at the same size. The chambers are arranged within heat conducting and storage material 420 that is heat insulated by the solar heat collector and insulations. A set of fit size utensils 4310, 4320 and 4330 (not shown in Figure) fit the sizes of the chambers for receiving solar heat from the heat conducting and storage material 420 for solar cooking. Second set of utensils 4311, 4321, and 4331 have a size smaller than the size of the chambers for supplementary energy heaters (as shown in the chambers). The chambers and utensils can also be arranged to have different sizes for transferring between solar cooking model and second heating model as discussed in FIG. 3. The supplementary energy heater can be any kind of electric heater such as resistance heater or induction heater as shown in FIG. 3 and descripted. Here it is an infrared heater comprising an infrared heating source 451, 452 and 453 and a power supply. A glass (e.g. ceramic glass) 455 isolated the utensil and the second heaters. The chambers have first open ends to receive the fit size utensils respectively for solar cooking. The second ends of the chambers are located on tops of predefined heating zones of electric heaters 451, 452 and 453. The appliance may also has an electric heater directly arranged under the cooktop 415 to receive any size utensil directly. Two vertical rotatable sunlight reflectors (e.g. plates) 415 and 416 (did not show) arranged at two sides of the appliance for reflect sunlight to the solar heat absorber 410. The reflectors may be closed to cover the transparent layer 411 of the solar heat collector after operation for protection purpose. The reflector may also foldable through a hinge 4160 to avoid a light scattering. A horizontal sunlight reflector or a reflecting coat 417 is arranged at the bottom and front of the appliance. The solar cooking appliance 40 further comprises an oven 490. A control panel 455 shows a control system which measure, indicate and control the temperatures of each utensil and the timing of cooking processing for utensils. The wall of the chamber 431-433 is made of light reflecting material (e.g. polished metal).

When the sun light 100 shines on the solar heat collector 40, the collector 410 absorbs the solar heat and transfers it to the heat conducting and storage material 420 and the chamber walls 431, 432 and 433 to cook the food in the utensils 4310, 4320 and 4330. When the solar heat is not enough for cooking, we change the utensils to the small size utensils 4311, 4321 and 4331. An air gap will be formed between the utensil wall and the chamber wall for heat insulation. When the heat insulation is taken out from the bottom of utensils, the bottom of the utensil will connect the glass plate 454 directly. To turn on the electricity, the infrared from the heater 451, 452 and 453 will heat the predefined zone that is under the bottom of the utensils. In this way the food can be cooked.

FIG. 4 further shows food and beverage packing container and utensil: 439, which in this case is a can, or the like. Utensil may for example be either a food container 71 or beverage container 72, e.g. as shown in FIG. 7. The solar cooking can may be similar to food and beverage cans on the market. The difference is that the can in this disclosure has a hole 4391 sealed by a removable seal. Before cooking, the seal needs to be removed for pressure release. A tube 472 of the assembled fluid channel at the multi-functional cover need to insert its one end into the can and the other of its ends connected to the hole of the cover. This is for preventing liquid leakage in the utensil.

A food bag 438 in chamber 432 of FIG. 4 may be as disclosed in detail in FIG. 7, e.g. food bag 73. The bag is made of material selected from paper, plastic, silicone gel, metal foil, (e.g. aluminum or steel foil), or a combination thereof. The food is cleaned and with condiment for keeping in refrigerator. The bag is evacuated, or filled with air or nitrogen. The bag has a removable seal tab for closing a hole. The tab needs to be removed before putting the bag into the solar cooking appliance for cooking. As discussed in FIGS. 2 and 3, the appliance 40 further comprise the utensils, multi-functional covers, assembly fluid channel etc. The description of these components in the aforementioned figures is also applicable to FIG. 4.

Referring to FIG. 5, a solar cooking appliance 50 for indoor user is illustrated in side view. The appliance comprises: a solar heat collector 51 for collecting and storing solar heat, arranged with its main part in outdoors 502 and an open end 511 extended directly to indoor and opened at indoor 501 directly; a solar cooking utensil 511 (shown in FIG. 5) arranged in said solar heat collector for cooking. The utensil 511 can put into and take out from said solar heat collector at indoor space 501. A rotatable sunlight reflector 52 is able to track the sunlight from sunrise to sunset without moving the solar heat collector (please refer to 1, 2 and 3 in FIG. 5). For example it rotates in a part or full cambered track 560 around its axis. A rotating device 56 is for rotating and controlling the movement of reflector 52. It is able to be operated and controlled indoors. An indoor monitor 562 for monitoring said solar cooking appliance 50. The controller and monitor may be in one device. In FIG. 5, indoor space Si and outdoor S2 are separated by a junction or interface 53. The interface 53 may be a wall of a space, e.g. a building. The example space S1 is a kitchen and dining room.

The interface 53 has a transparent or translucent window 531 for cook and dinner to monitor the outside part of the solar cooking appliance 50. The monitor can also be an outdoor monitoring camera 5310 with a screen 562 indoors. Other watching tools are also could be used.

The solar heat collector 51 can be any kind of solar heat collector for cooking, e.g. an evacuated solar heat collector with integrated food cooking features in one compact unit. The chamber 510 of collector 51 comprises a utensil 511 and a multi-functional cover 512. They are same as the utensil 1301 and 1302 and the multi-functional cover 1401 and 1402 disclosed in details in the description of FIG. 1. The features described can be selectively copied to here.

The chamber 510 may also comprise a removable and modular heat conducting and storage material. The material comprises at least first unit 513 and second unit 514. The first unit comprises a removable, replaceable and modular unit mainly for heat transferring. 513 may be an empty cylinder made of heat conductive material, e.g. metal. The second unit 514 may be 513 contained with a heat storage material, e.g. sand or salt. The heat storage material is able to be received in and removed out from the cylinder. The first unit 513 and second unit 514 have same size and shape to fit the size and shape of the inner space of solar heat collector, e.g. chamber 510. The heat conducting and storage material in unit 514 can be any one that introduced before. The number of unit 513 and 514 are more than one. They are transferrable and replaceable each other. So the solar cooking speed is adjustable by adjust the unit numbers of 513, 514 and their ratio. The chamber may further comprise an elastomer 515 to protect the gravity impact from the components of the chamber.

The reflector 52 is for reflecting the sunlight 100 to the solar heat collector 51. The reflector 52 can be any kind of sunlight reflector. Here it is an elongated reflector having a circular arc shaped cross section with a circular arc angle θ, as shown in 7 of FIG. 5. Therefore the reflector 52 has all reflecting focuses (in ½ radius of the circular arc) in the solar heat collector, also as shown in 7 of FIG. 5. The rotating device 56 including the rotating guides 560 and 563 allows the reflector to rotate around its axis. The reflector rotates to cover an angle between west side (1), bottom front (2) and east side (3) or in a 360 degree (1-4). Therefore when the appliance 50 is in operation, the reflector 52 can reflect the sunlight 100 from sunrise to sunset to heat the utensil and cook the food. There is no need to move the solar heat collector. The rotating device 56 can selectively comprise a manual controller, a remote controller or an automatic controller. In FIG. 5, the rotating device 56 is a remote automatic rotation device 562. It may comprise a motor 561, rotating track 563 and a controller 561 and a control operation computer 562. Here only 562 is within Sl. 55 is drawing pole. The motor can be arranged at the end, front or middle of the solar heat collector. The controller may also comprise a computer program to track the sun movement automatically every day. 55 is an angle adjust device for the solar heat collector. The user can select or not select this device.

The rotating controller of said reflector 52 is located indoors so that a cook located indoors is able to operate the solar cooing appliance 50. For example: a control handle may be located indoors, if said controller is manual; a control button may be located indoors, if the controller is an electric controller; an operating computer of a remote controller may be located indoors. Here a setting and operating device (e.g. a computer 562) is indoors, and the controller is computer program controlled. The rotation may be controlled in 24 hours for a cycle or by sunlight direction.

In some cases, to make the rotation of the reflector 52 easier, the reflector may be made of a light and very thin plastic sheet (e.g. thinness less than 0.5 mm) with a reflecting coat on the surface. Alternatively, the rotated part is a transparent closed hollow cylinder or part of cylinder. The transparent hollow cylinder may be coated with the reflecting material partially. The other part may be kept transparent for the protection of solar heat collector.

The solar cooking appliance may have an electric heater either selectively arranged in the utensil 511, the multi-functional cover 512 or located in the chamber of solar heat collector 51. This kind of heater has a very high efficiency. An alternative way is to have a second energy cooking device 54 arranged near to or under the open end 511, or to put the open end 511 close to an existing range 54 in a kitchen. The supplementary energy heater 54 can be selected from a group of electricity heater, fossil fuel heater and a biomass heater as introduced before. Here 54 is an electric stove in a kitchen. When food is cooking, the second energy cooking appliance 54 provides an auxiliary energy to solar. It makes the solar cooking indoors possible at any time regardless of whether sunlight is abundant at the time.

Historically, most solar cooking appliances need to change its direction and angle of the appliances to track the movement of sunlight. In contrast, the reflector 52 can rotate in 360 degree and around clockwise direction (in northern hemisphere). We can use a longer solar heat collector 51 and arrange the collector at a stable situation and a fixed angle β for all operation time. This arrangement makes the high efficiency solar cooking appliance for indoor user become achievable. The appliance 50 is simple, cost effective and with high efficiency. To get the highest efficiency for this kind appliance in different areas, the best angle β needs to be calculated and decided by the geographic data. As higher the geographic latitude, as larger the angle β is suggested. Furthermore we can also arrange an angle β adjusting structure 55. It allows the collector 51 rotated between β to 0 degree in a vertical face perpendicular to the ground. Therefore, in summer, the appliance 50 can receive more solar energy. In some special cases, we also can arrange the solar heat collector 51 to rotate in a face perpendicular to ground with the angle β between 0-90 degrees. In this case, 51 is short enough. Then the angle 13 should be adjusted every month, week or day. This case is illustrated in side view, case 5 of FIG. 5, Another alternative arrangement is to keep the angle β at 0 degree. Then to rotate the solar heat collector 51 around its open end 511 in a face parallel to the ground. This case is illustrated in a top view, at case 6 of FIG. 5,

In FIG. 5, the sub-figures 1-4 show a 24 hours rotating circle of the reflector, either continued rotating by program, or intermittent rotating manually. At four time periods of morning, noon, afternoon and night, the facing of reflector 52 is changed from eastward, upward, westward and downward to track the sunlight movement at day time. At night time, the reflector 52 will cover the solar heat collector to protect the evacuated tube. Of couse, it is not necessary the reflector is a completed one piece and the entail reflector needs always to rotate in a 360 degree. The reflector can be separated in two or more prices too. The key point is that the sunlight reflector is able to rotate around its axis and the rotating track of cross section of said reflector being able to cover a 360 degree circle. The reflector 52 may also be replaced by an incident sunlight focuser (not shown in FIG. 5). The focuser covers the solar heat collector and focuses the incident sunlight to the solar heat collector. In this case the rotating device is not required. Because the reflector can be rotated to cover a 360 degree circle. Therefore the reflector not only can reflect the sunlight to the solar heat collector follow the sunlight movement. It also can partially or fully cover the solar heat collector from sunlight, if necessary. Thus the solar heat can be turn on/off and be controlled by control the location and angle of the rotatable reflector.

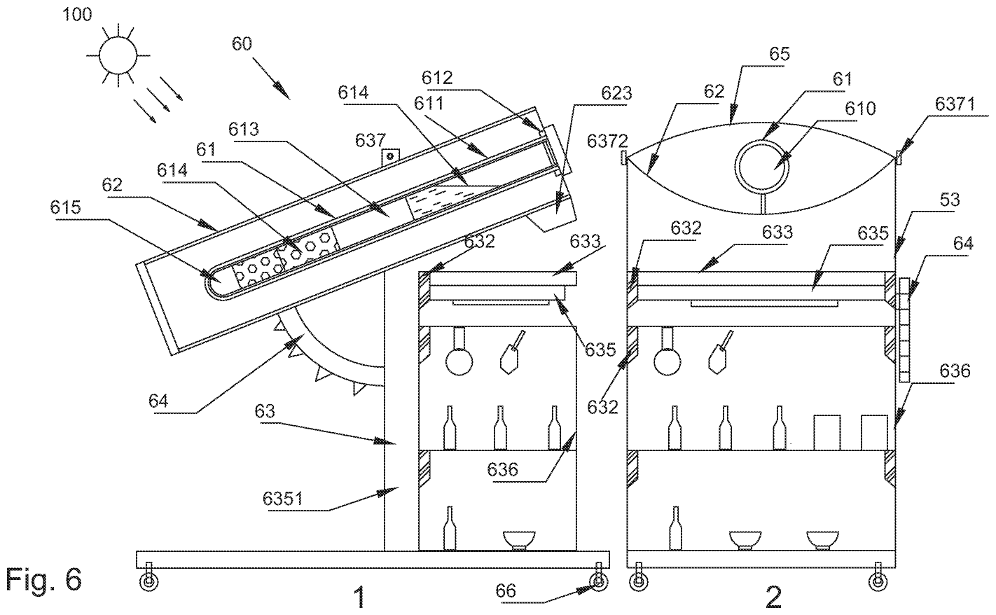

Referring to FIG. 6, an outdoor solar cooking appliance 60 is illustrated in side view and front view. The appliance comprises: a solar thermal unit comprising a solar heat collector 61 for collecting and storing solar heat. A chamber 610 of collector 61 receives a solar cooking utensil 611 for food cooking. A multi-functional cover 612 covers said utensil and may also cover the chamber 610. A reflector 62 focuses and reflects sunlight to the solar heat collector. A stent 63 assemble and support the elements of the appliance. The stent comprises a receiving structure to receive and detach a kitchen supplies.

The solar heat collector 61 can be any kind of solar heat collector, e.g. an evacuated solar heat collector. It comprises two layers of glasses or outer layer of glass with interior layer of metal. A solar heat absorbing coating is applied on the interior layer. The space between two said layers is evacuated for heat insulation. The chamber 610 of collector 61 comprises a utensil 611 and multi-functional cover 612. They are as discussed in details above. They can be used in appliance 60. The features described before can be selectively copied to here. The chamber 610 may comprise a modular heat conducting material 613 and a modular heat conducting and storing material 614 to store and transfer solar heat to said utensil. They have standard sizes. For example, 613 is an empty cylinder with standard size and made of heat conductive material e.g. metal. The heat storage material can be any heat storage material introduced in our prior patent applications. Materials 613 and 614 are transferrable each other by put in and take out the heat storage material. So the solar cooking speed is adjustable. The chamber may further comprise an elastomer 615 to protect the gravity impact from the components of the chamber.

As noted above a stent 63 supports the solar thermal unit. The stent comprises a receiving and connecting structure for receiving and attaching kitchen supplies. The attached applies may be selected from a group of: a square frame, a cook top, an electric heater, a cabinet to store foods and kitchen applies or a hooks to hold a kitchen supplies etc. All of them are able to attach to and detach from the appliance. As an example, a short section of tube 532 can be welded onto the stent. A square frame 533 can be attached to the stent. The frame can receive a removable flat plate as cook top. The frame also can receive an electric heater (e.g. an electric induction heater) as a supplementary energy heater. A cabinet 635 is also can attached to the appliance.

An angle adjust device 64 is for adjusting the angle of solar thermal unit from near 90 degree to 0 degree, Any angle adjusting devices, such as many existing window openers, can be used as the adjusting device. Here it is an arc shaped supporting bar with saw teeth. Each serrated defines a special angle for the appliance. If we make the number of the saw teeth as the multiple number or common divisor of 6, (e.g. 3, 6, 12 etc.) then each defined saw teeth may correspond to a special month, two months or half month. The adjustor 64 also can be replaced by a rope connected the end of the reflector. A wheel 66 is for the appliance to track the sunlight movement from morning to evening. A rotatable reflector as disclosed in FIG. 5, can also be used in which case the wheel 66 may be not necessary.

The reflector 62 can be any kind of the sunlight reflector. Here it is shaped as circular arc. A hoop connects and supports the sunlight reflector 62. Two rotating axes at the two ends of the hoop extend into two rotating bases 6371 and 6372 at the stent for the reflector to rotate around the bases. A sun shadow indicator may help to adjust the vertical and horizontal angles of the appliance. (not shown)A computer program also can be used for the appliance to track the sunlight movement. At two edges of the reflector, there may be two slots for an inserted transparent plate 65 for protecting the solar heat collector 61. The second heater can be the attached electric heater 633, it also can be a electric heater in chamber 514 or in the multi-functional cover. They are described before. The second heat also can be a BBQ stove or others. There may also be a umbrella (did not shown) for chef's shade.

Referring to FIG. 7, a group of exemplary solar cooking utensils (containers and packages) 71, 72 and 73 are illustrated. The prepared food and beverage can be packed inside the utensils. The prepared food and beverage may be raw, cooked or half-baked. The utensils can be made of various materials, mainly the heart conducting material such as metal film and foil, plastic film, silica gel, plant fiber fabric, paper, plant reef and shell including their combinations thereof may be used. The prepared food and beverage in the cooking utensils will be ready for cooking or warming in the solar cooking appliance. After cooking, the diner can eat or drink directly from the utensils if they do not want to transfer the food or beverage to tableware, such as plates, bowls, cups or others. Therefore the utensils 71, 72 and 73 can be considered as “3 in 1” cookware. They act as packagers and containers before cooking, utensils during solar cooking and tableware when eating. After eating or drinking is completed, the utensils may not require washing for saving clean water. They used utensils can be simplely recycled to reduce the pollution. Utensil 71 may be a food can, or the like, having a hard wall 711 and bottom 715 made of steel, aluminum or alloy. A removable seal 712 made of metallic foil is attached on the top of 71. It can be removed after cooking and before eating. A plastic cover 716 covers the utensil 71 before putting 71 into solar cooking appliance. The seal 713 is for seal a breathing hole on the utensil (not shown) to receiving a breathing tube. When the seal 712 does not exist, the cover 716 can be a metallic cover inserted into the utensil 71to cover it. The cover 716 may also be a fixed part of the utensil 71.

A breathing hole 717 is intended to receive a breathing tube. The beverage can 72 has a wall 721, bottom 723, a tab 722 on the top for open the can. It may be similar to the beverage cans already on the market, One difference is the presence of breathing hole 723 with a removable seal 724. The seal 724 may also be a seal can be closed. The utensils 71 and 72 may have a pleated structure (not shown in drawing) at their wall for air release and or a cable of electric heater. The utensil 73 has a soft wall 731 whichmay be made from a film or foil made of metal, plastic, ceramic gel or other soft material. The prepared food (e.g. fresh vegetable may store in the bag for solar cooking. Again, there is a breathing hole 733 and a seal 734. A resealable closure732 (e.g. a zipper or push zipper) may allow food to be accessed and the bag to be resealed.

In FIG. 7, each utensil has a breathing hole or vent. Sometime, it may not be required, if the inner space of the utensil does not generate enough pressure, or no fluid is required to transfer to out of the utensil. Most of the existing metallic food or beverage cans and bags can become a solar cooking utensil. The only modification that may be required is the provision of a breathing port or outstanding port (e.g. 717, 723 or 733) with a removable seal (e.g. 713, 724 or 734). The hole is for receiving a fluid channel, e.g. a tube. Examples of utensils 71, 72 and 73 in a solar cooking appliance include utensils 439 and 438 of FIG. 4.

Please note that for brevity, a component of a solar cooking appliance may be described in details herein in one paragraph or for only one sample solar cooking appliance. But the descriptions they may be applicable to other sample solar cooking appliances described herein.

Other modifications will be apparent to those skilled in the art and, therefore, the invention is defined in the claims.

What is claimed is:

1. A solar cooking unit comprises:
a solar thermal unit comprising: at least one solar heat collector for collecting solar heat;
a chamber of said solar heat collector for receiving a utensil that contains food, water or a beverage, and said utensil thermally connected to said solar heat collector to receive and transfer said solar heat to said utensil for cooking; and
a sunlight focuser to focus the sunlight to said solar heat collector, wherein said sunlight focuser has a cross section with a circular arc shaper, and a semi-diameter R; and
wherein the axis of said solar heat collector is arranged at center of said cross section with a circular arc shape and at location of or very close to ½ R height of said sunlight focuser.

2. A solar cooking unit comprises:
a solar thermal unit comprising: at least one solar heat collector for collecting solar heat;
a chamber of said solar heat collector for receiving a utensil that contains food, water or a beverage and said utensil thermally connected said solar heat collector to receive and transfer said solar heat to said utensil for cooking;
a sunlight focuser to focus the sunlight to said solar heat collector; and
a multi-functional cover covered said utensil; and said cover comprising an electric heater with power supply.

3. The solar cooking unit according to claim 1,
wherein said sunlight focuser is a sunlight reflector that is rotatable around said solar heat collector along a 360 degree circular path.

4. The solar cooking unit/appliance according to claim 1,
wherein said at least one solar heat collector comprises first and second solar heat collectors and
wherein said solar thermal unit is a modular solar thermal unit further comprises:
a first sunlight reflector for said first solar heat collector having a cross section with a circular arc shape;
a second sunlight reflector for said second solar heat collector having a cross section with a circular arc shape;
a connecting part connecting said first and second said sunlight reflectors; the connecting part allowing movement of said first and second sunlight reflectors relative to one another between an open position and a closed position; wherein, in the open position, each of said first and second sunlight reflectors is oriented to reflect sunlight to a respective focus point located in said first and second solar heat collector respectively, and wherein, in the closed position, said first and second sunlight reflectors collectively form a pipe enclosing said first and second solar heat collectors.

5. The solar cooking unit/appliance, according to claim 1 further comprises:
a stent/stand for assembling and supporting said solar thermal unit, said stent/stand comprising a receiving structure to removably receive and detach a kitchen supplies.

6. A solar cooking appliance comprises:
a solar thermal unit comprising: at least one solar heat collector for collecting solar heat;
a chamber of said solar heat collector for receiving a utensil that containing food, water and a beverage;
and said utensil thermally connected said solar heat collector to receive and transfer said solar heat to said utensil for cooking;
a multi-functional cover covered said utensil; and
wherein said solar thermal unit further comprising a supplementary energy heater; and said chamber having first open end to receive said utensil and second end located on top of a predefined heating zone of a supplementary energy heater; and a removable heat insulation separator isolating said chamber from said supplementary energy heater.

7. The solar cooking appliance according to claim 3, wherein said supplementary energy heater is selected from a group of:
electric heater; oil heater, gas heater, coal heater, and biomass heater;
wherein said electric heater is selected from a group consisting of a microwave heater; an infrared heater;
a resistant heater; an immersion heater; an induction heater and a light heater using light source as a heat source;
and wherein said electrically powered heater is powered by electricity from one of: a power bank, a vehicle battery, a solar electric generator and an electric utility; a power transformer; a power adapter and a power frequency converter.

8. The solar cooking appliance according to claim 1, wherein said sunlight focuser is selected from a group of:
a reflecting sunlight focuser to reflect and focus sunlight onto solar heat collector; and
an refracting sunlight focuser to refract and focus sunlight onto solar heat collector;
and wherein said sunlight reflector is selected from a group of:
a semi-round pipe and having central line of said evacuated tube located in or approximately in the location of the half radius of said semi-pipe;
a sunlight reflector having a cross section with a circular arc shape, positioned so that a reflecting focus of said sunlight reflector is located in said solar heat collector;
a sunlight reflector having a rotating device;
a sunlight reflector having a rotating device with a motor;
a sunlight reflector having a rotating device with a control device;
a sunlight reflector having a rotating device and control device for causing the sunlight reflector to rotate through a circular path in 24 hours; and
a sunlight reflector having a rotating device controling the rotating based on an incident angle of sunlight.

9. (canceled)

10. The solar cooking appliance according to claim 1, wherein said utensil is first utensil and further comprises:
a second utensil capable of containing a liquid or a gas/steam;
a flexible and assembled fluid channel removably and selectively connectable between said first utensil and said second utensil for fluid communication therebetween; and
said fluid channel having a feature to communicate liquid in one way and to communicate gas in two ways.

11. The solar cooking unit according to claim 3, wherein said chamber is selected from a group considering of:
an inner space defined by an inner layer of an evacuated tube solar heat collector;
a space in a heat conducting and storage material placed in a flat or camber plate solar heat collector;
a space defined by a wall arranged in an insulated compartment placed by heat conducting and storage material, wherein said heat conducting and storage material is thermally connected to the solar heat collector;
at least two chambers with two different sizes;
a chamber with a wall made of or containing non-ferromagnetic material;
a chamber with a wall made of or containing ferromagnetic material;
a chamber located on the predefined heating zone of the supplementary energy heater and a heat insulation separator separated said supplementary energy heater from said chamber;
a chamber located on the predefined heating zone of the supplementary energy heater and a ceramic glass separator separated said supplementary energy heater from said chamber;
a chamber located on the predefined heating zone of an induction energy heater with heat insulation and non-ferromagnetic material separating said induction heater and said chamber;
a chamber having a wall with infrared reflecting feature; and
a chamber arranged on the designed heating zone of a ceramic glass, said ceramic-glass having an electric-heat coating with power supply.

12. The solar cooking unit according to claim 1, wherein said multi-functional cover is selected from a group considering of:
a cover having a mechanical locking structure to lock the cover to the utensil as an airtight container and to make the cover as a handle for moving the utensil;
a cover having three parts fixed or removeably assembled together for covering the utensil, the gap between utensil and chamber and the gap between the chamber and cook top;
a cover being able to be used for covering the second open end of the chamber and with a electric heater; and
a cover having an electric connector connected to power source and being able to removeably receive an electric heater, and said electric heater entered into said utensil for cooking.

13. The solar cooking unit according to claim 1 wherein said heat conducting and storage material is selected from a group of:
at least first and second modular, removable and replaceable units of heat conducting and storage material having same size and shape to fit the size and shape of the inner size and shape of said solar heat collector;
wherein said second unit has a larger heat capacitance than heat capacitance of the first unit;
at least two units of modular solar heat conducting and storage material mainly for heat conducting, said unit having same size and shape to fit the size and shape of the inner size and shape of said solar heat collector; and a second heat conducting and storage material mainly for heat storage; and wherein said second material being able to be received in and removed out the units of the first material;
a cylindrical hollow heat conducting material;
a cylindrical hollow heat conducting material able to receive and remove a heat storage material;
a non-ferromagnetic material;
a ferromagnetic material;
a cylinder container containing ferromagnetic material having a size smaller than size of said chamber; and
a material admixable with food for transferring heat to food to promote uniform heating of the food.

14. The solar cooking appliance according to claim 1, wherein said utensil is selected from a group of:
first utensil and second utensil, an assembled fluid channel removeably and selectively connects said first utensil and second utensil for fluid communication; and said fluid channel having a feature for one way fluid communication and two ways of gas communication;
a utensil containing or made of ferromagnetic material heatable using an induction heater;
a utensil containing non-ferromagnetic material;
at least two different size utensils to fit the sizes of two chambers with different sizes;
a disposable utensil;
at least a larger size utensil and a smaller size utensil, said larger size utensil fitted the size of a chamber and smaller size utensil having a gap between the utensil wall and the chamber wall for heat insulation;
a utensil having a size smaller than the size of said chamber and having a bottom containing ferromagnetic material;
a utensil having a ferromagnetic material attached for said induction heater;
a set of utensil with different sizes from smaller to larger for fit a set of said chambers having same sizes from smaller to large; and
a transparent evacuated utensil made of non-ferromagnetic material and having a ferromagnetic material within said utensil.

15. The solar cooking appliance according to claim 1, wherein said utensil comprising a disposable solar cooking utensil selected from a group of:
an airtight bag for containing food or beverage having a hole with a removable seal, the size of the hole fitted the size of said fluid channel;
a watertight can for containing a food or beverage, the can having a hole sized to snugly receive a tube defining a channel for fluid, the hole having a removable seal;
a watertight can for containing a food or beverage, the can having a tab for opening said can;
a watertight can for containing a food or beverage, the can having a hole sized to snugly receive a tube defining a channel for fluid, the hole, and the hole having a removable seal;
a watertight can for containing a food or beverage, said can having a tab for opening side can and a hole sized to snugly receive a tube defining a channel for fluid, the hole, and the hole having a removable seal;
a carton for containing a food or beverage, the carton having a hole sized to to snugly receive a tube defining a channel for fluid, the hole having a removable seal; and a disposable utensil containing ferromagnetic material.

16. The solar cooking unit according to claim 3, wherein said solar thermal unit comprises a camber/curve solar cooking unit, comprising:
first camber transparent layer and second camber layer for absorbing solar heat, said first and second layers are insulated by air or evacuated;
a heat conducting and storage material placed in a camber space defined by insulation and said second camber layer and thermally connected to the solar heat absorber;
said heat conducting and storage material being heat insulated;
at least two chambers arranged in the heat conducting and storage material, and each said chamber having first open end to receive said utensil and second open end located on top of a predefined heating zone of a supplementary energy heater;
a heat insulated and non-ferromagnetic material (e.g. ceramic glass) separating said chamber from said supplementary energy heater;
a control panel for measuring, indicating and/or controlling the solar thermal unit; and
a vertical light reflector and a horizontal light reflector for reflect sunlight to said absorber.

17. (canceled)

18. The solar cooking unit according to claim 3, wherein said solar thermal unit further comprises: a heat conducting and storage material thermally connected to each of said solar heat collector and a ceramic glass; wherein said chamber is arranged in said heat conducting and storage material; and said chamber having first open end to receive said utensil and second open end located on top of a predefined heating zone of a cooking heater emerged by a supplementary energy heater; and the ceramic glass separating said chamber from said supplementary energy heater; wherein said second energy is a non- solar energy.

19. (canceled)

20. The solar cooking unit according to claim 2 comprises an electric heater selected from a group of:
an electric resistant heater;
an induction heater;
an infrared heater;
a light heater; an immersion heater;
a radiated heater;
a microwave heater ;
an electric-heat coating heater;
a portable immersion electric heater removeably arranged at said multi-functional cover;
a portable infrared heater removeably arranged at said multi-functional cover;
a portable microwave heater removeably arranged at said multi-functional cover
an induction heater removeably arranged at said multi-functional cover; having a tubular coil arranged inside of the first utensil;
an induction heater having a tubular coil removeably arranged at said multi-functional cover;
an induction heater having a tubular coil removeably set at outside of said first utensil and solar heat collector;
an induction heater having a tubular coil removeably set at outside of said heat storage material and solar heat collector; an AC or DC electric heater having a low and safety voltage; an electric heater with a transformer; electric heater with an adapter; and
an electric heater with sensor and controller.

21. The solar cooking unit according to claim 3 further comprises an induction cooking heater/element to form a solar-electric induction cooking appliance, comprises:
a high frequency AC electric power source; an electric coil connected to said power source, said coil having shape and size to fit shape and size of said cooking chamber or said utensil of a solar cooking unit;
said wall of said chamber made of non-ferromagnetic material and having first open end to receive said utensil and second open end located on top of a predefined heating zone of said induction cooking heater;
a heat insulated and non-ferromagnetic material separator separated said chamber from said induction heater; a temperature sensor or a thermostat; a fan for temperature control; and a controller.

22. The solar cooking unit according to claim 3, wherein said utensil is first utensil and said chamber is first chamber, and further comprises:
a second chamber larger than the first chamber, the second chamber for receiving either a second utensil that contains food, water or a beverage, the second utensil being larger than first utensil, or for receiving the first utensil with gap between a wall of the first utensil and a wall of the second chamber, the gap acting as a heat insulator.

23. (canceled)

24. (canceled)

25. (canceled)

26. The solar cooking unit/appliance according to claim 1, further comprises one or more components selected from a group of:
a water tube for transferring generated hot water from said cooking utensil; a fan thermally connected to said solar heat conducting and storage material for space heating or cooling; a frame and/or supporter to connect and support the components of the unit/appliance; a weal to move the appliance; a heat driven self-circulation device for circulating solar heated liquid by said unit; an elastic object arranged in said solar heat collector for shock protection thereof; a receiving structure arrange at said solar cooking appliance for receiving or detaching a removable kitchen supplies; a cook top; a cabinets; a handle; an elastomer; a reflector; a cover, a shade umbrella for cook; a transparent cover arranged in a slot of said reflector to protect the solar heat collector; and a potable table having a gap to receive said solar heat collector and a desktop to form a cooktop of said solar cooking unit/appliance.
